(19) United States
(12) Patent Application Publication
(10) Pub. No.: US 2015/0339015 A1
(43) Pub. Date: Nov. 26, 2015

(54) SELECTING AND PRESENTING ITEMS OF CONTENT BASED ON ESTIMATED TIME TO COMPLETE

(71) Applicant: Kobo Incorporated, Toronto (CA)

(72) Inventors: James WU, Toronto (CA); Robert MACARTHUR, Toronto (CA); Nina REHULA, Toronto (CA)

(73) Assignee: Kobo Incorporated, Toronto (CA)

(21) Appl. No.: 14/284,624

(22) Filed: May 22, 2014

(51) Int. Cl. G06F 3/0483; G06F 3/0482

(52) U.S. Cl. CPC G06F 3/0483; G06F 3/0482

(57) ABSTRACT

A graphical user interface (GUI) element is displayed on a display screen (e.g., a touchscreen) of a computing system (e.g., an electronic-book reader). In response to the GUI element being selected by a user, different items of content are accessed. A duration value that indicates a length of time is associated with each item of the items of content. Information identifying at least a subset of the items of content is displayed on the display screen, where the subset is selected according to the duration values.

### BACKGROUND

Tablet computer systems, electronic-book (e-book) readers, smart phones, and other types of portable devices are increasingly popular. These types of devices have features in common, such as high resolution touchscreens that provide an easy-to-use, intuitive user interface that allows users to interact directly with what is being displayed.

In an e-book reader, for example, a page of an e-book is rendered and displayed. The electronic version of the page that is displayed looks very much like the conventional non-electronic version of the page.

A user frequently may have a multiplicity of items of content in various stages of reading progress: items that the user has not yet started to read, or has started to read but has not yet completed, referred to herein as “current reads.” The items can include, for example, e-books, e-magazines or e-magazine articles, and e-comics that have been downloaded to the user's reader and/or are accessible via one or more reading devices linked to the user's e-reading account or e-library collection. Thus, when trying to decide which item to read, a user may have a number of choices.

### SUMMARY

Furthermore, on some occasions, a user may have only a limited amount of time to read. For example, a user might have only a 15-minute window of time available between appointments. Under these kinds of circumstances, it would be helpful if the user could be presented with an organized selection of current reads that could be completed within the available window of time. Embodiments according to the present invention provide this capability.

In embodiments according to the invention, a selection of items of content (e.g., current reads) that matches an available window of time in a user's schedule is presented to the user. An item of content is not necessarily an entire book or magazine, for example; an item of content may be, for example, one or more chapters in a book or one or more articles in a magazine. The length of the window of time may be explicitly indicated by the user as a period of time that is suitable/desirable for reading, or it may be automatically inferred from calendar and/or other scheduling information associated with the user.

In an embodiment, one or more items of content are selected for presentation to the user based on a “most likely to be completed” criterion. Each most likely to be completed selection of an item of content is one in which an estimate of the time it will take to complete reading the item of content fits into the available window in the user's schedule. For example, if a 15-minute time slot is available for reading, information identifying one or more items of content that are likely to be completed within that time slot could automatically be presented on the reading device's display. Alternatively, information identifying one or more items of content that are a “best fit” to the available time slot could be presented (e.g., if a 15-minute time slot is available, then an item of content with a 14-minute estimated time-to-complete would be identified over one with an estimated time-to-complete of five minutes). Generally speaking, a prioritized list from among the current reads can be presented to the user, giving the user more control over reading selections.

Estimated times-to-complete may be based on, for example, statistics for the particular user tracked on the user's reading device, more global statistics (e.g., tracked across different users) for a particular item of content, or statistics tracked for similar items in the user's e-reading library or account.

More specifically, in an embodiment, a graphical user interface (GUI) element is displayed on a display screen (e.g., a touchscreen) of a computing system (e.g., an e-book reader). In response to the GUI element being selected by a user, different items of content are accessed. A duration value that indicates a length of time (e.g., time-to-complete) is associated with each item of the items of content. Information identifying at least a subset of the items of content is displayed on the display screen, where the subset is selected according to the duration values.

In an embodiment, an amount of time that is available for reading is determined, and the subset is selected based on a comparison between the duration values and the amount of time that is available. An input indicating the amount of time that is available may be received from the user. The amount of time that is available may also be automatically determined by accessing schedule information associated with the user.

In an embodiment, information that indicates a rate at which content is read can be accessed, and the rate information can be used to determine the duration values. In such an embodiment, the rate may be a function of the type of content (e.g., a rate can be determined for fiction books, another rate for non-fiction books, yet another rate for magazines, and so on).

In an embodiment, the information displayed on the display screen is organized according to the duration values. For example, the subset of items presented for displayed may be sorted from the shortest duration value (the shortest time-to-complete) to the longest.

In summary, embodiments according to the present invention facilitate selecting an item of content for reading based on how well an estimate or prediction of the amount of time needed to complete reading the item of content fits into the time a user has available for reading. People can more quickly make informed decisions about which item of content to read, particularly when they can choose from a multiplicity of items of content in various stages of reading progress. As a result, people will be able to fit more reading into their everyday lives.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A is a block diagram of an example of a computing system capable of implementing a reading selection program in embodiments according to the present disclosure.

FIG. 1B illustrates items of content stored in memory and accessible to a reading selection program in embodiments according to the present disclosure.

FIG. 2A illustrates a frontal view of an example of a computing system, showing a display screen and an on-screen GUI element, in an embodiment according to the present invention.

FIGS. 2B and 2C are examples of GUIs that can be displayed on a display screen for a reading selection program in embodiments according to the present disclosure.

FIG. 3 is another example of a GUI that can be displayed on a display screen for a reading selection program in embodiments according to the present disclosure.

FIG. 4 is another example of a GUI that can be displayed on a display screen for a reading selection program in embodiments according to the present disclosure.

FIG. 5 illustrates an example of a reading selection program accessing schedule information in embodiments according to the present disclosure.

FIG. 6 is another example of a GUI that can be displayed on a display screen for a reading selection program in embodiments according to the present disclosure.

FIG. 7 is a flowchart of an example of a computer-implemented method for selecting and presenting items of content based on estimated time to complete for in embodiments according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

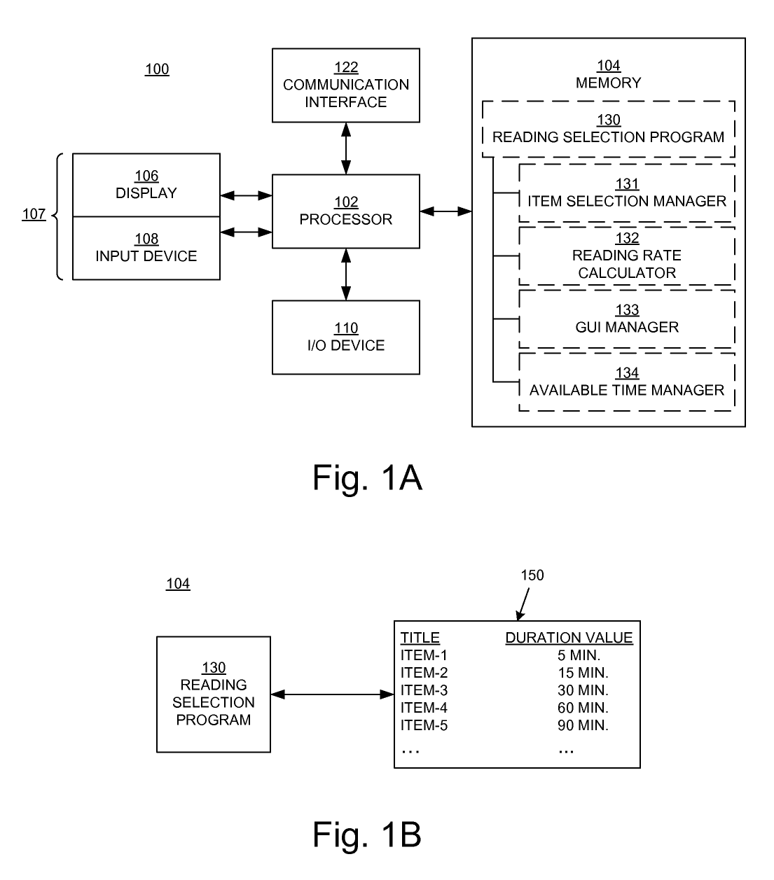

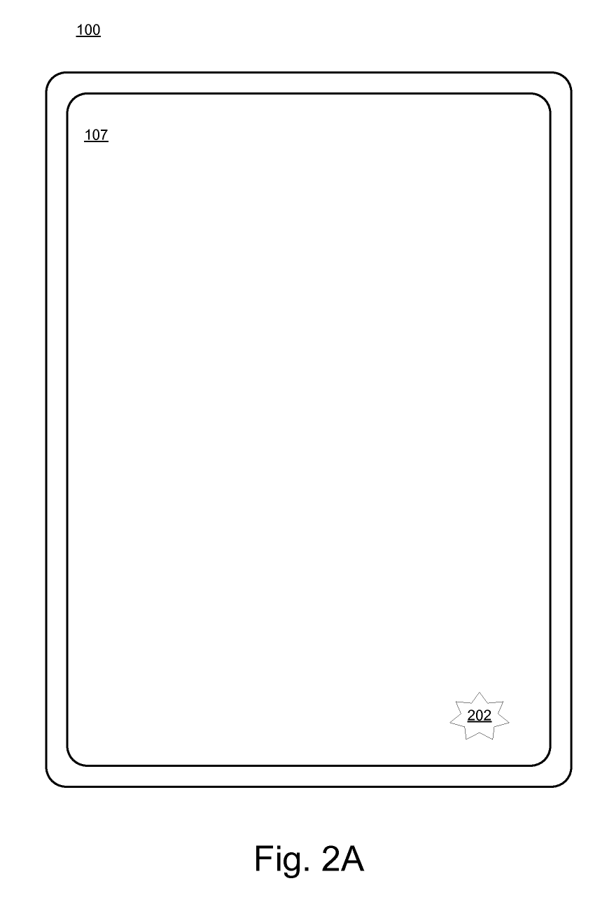

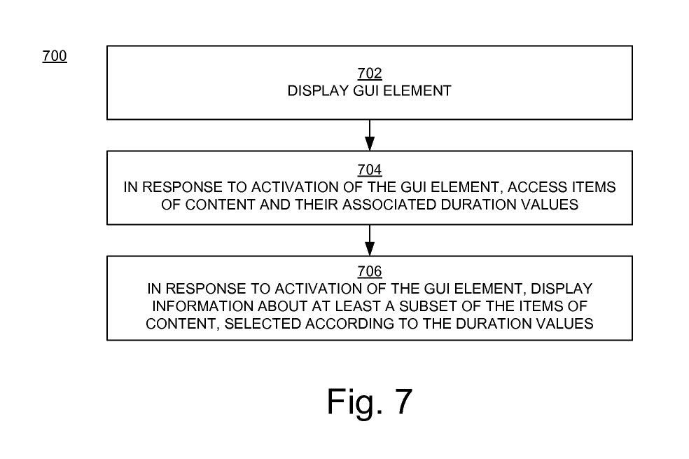

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “displaying,” “selecting,” “determining,” “using,” “receiving,” “organizing,” “sensing,” or the like, refer to actions and processes (e.g., flowchart 700 of FIG. 7) of a computer system or similar electronic computing device or processor (e.g., the computing system 100 of FIG. 1A). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1A is a block diagram of an example of a computing system or computing device 100 capable of implementing embodiments according to the present invention. The computing system 100 broadly represents any single or multi-processor computing device or system capable of executing computer-readable instructions. Examples of a computing system 100 include, without limitation, an electronic book (e-book) reader, laptop, tablet, or handheld computer. The computing system 100 may also be a type of computing device such as a cell phone, smart phone, media player, camera, or the like. Depending on the implementation, the computing system 100 may not include all of the elements shown in FIG. 1A, and/or it may include elements in addition to those shown in FIG. 1A. In general, the computing system 100 may be referred to herein as a reading device.

In its most basic configuration, the computing system 100 may include at least one processor 102 and at least one memory 104. The processor 102 generally represents any type or form of processing unit capable of processing data or interpreting and executing instructions. In certain embodiments, the processor 102 may receive instructions from a software application or module. These instructions may cause the processor 102 to perform the functions of one or more of the example embodiments described and/or illustrated herein.

The memory 104 generally represents any type or form of volatile or non-volatile storage device or medium capable of storing data and/or other computer-readable instructions. In certain embodiments the computing system 100 may include both a volatile memory unit (such as, for example, the memory 104) and a non-volatile storage device (not shown).

The computing system 100 also includes a display device 106 that is operatively coupled to the processor 102. The display device 106 is generally configured to display a graphical user interface (GUI) that provides an easy to use interface between a user and the computing system.

The computing system 100 also includes an input device 108 that is operatively coupled to the processor 102. The input device 108 may include a sensing device (a “touchscreen”) configured to receive input from a user and to send this information to the processor 102. The term “touchscreen” is used in the widely accepted manner to include any type or form of sensing device that can sense a user input, including those types of devices that do not require a touch; that is, some touchscreens can sense a user's finger or a stylus that is near (but not touching) the surface of the touchscreen. The processor 102 interprets the sensed input in accordance with its programming. The input device 108 may be integrated with the display device 106 or they may be separate components. In the illustrated embodiment, the input device 108 is a touchscreen that is positioned over or in front of the display device 106. The input device 108 and display device 106 may be collectively referred to herein as a touchscreen display 107. There are many different technologies that can be used to sense a user's input, such as but not limited to technologies based on capacitive sensing and technologies based on resistive sensing.

The communication interface 122 of FIG. 1A broadly represents any type or form of communication device or adapter capable of facilitating communication between the example computing system 100 and one or more additional devices. For example, the communication interface 122 may facilitate communication between the computing system 100 and a private or public network including additional computing systems. Examples of a communication interface 122 include, without limitation, a wired network interface (such as a network interface card), a wireless network interface (such as a wireless network interface card), a modem, and any other suitable interface. In one embodiment, the communication interface 122 provides a direct connection to a remote server via a direct link to a network, such as the Internet. The communication interface 122 may also indirectly provide such a connection through any other suitable connection. The communication interface 122 may also represent a host adapter configured to facilitate communication between the computing system 100 and one or more additional network or storage devices via an external bus or communications channel.

As illustrated in FIG. 1A, the computing system 100 may also include at least one input/output (I/O) device 110. The I/O device 110 generally represents any type or form of input device capable of providing/receiving input or output, either computer- or human-generated, to/from the computing system 100. Examples of an I/O device 110 include, without limitation, a keyboard, a pointing or cursor control device (e.g., a mouse), a speech recognition device, or any other input device.

Many other devices or subsystems may be connected to computing system 100. Conversely, all of the components and devices illustrated in FIG. 1A need not be present to practice the embodiments described herein. The devices and subsystems referenced above may also be interconnected in different ways from that shown in FIG. 1A. The computing system 100 may also employ any number of software, firmware, and/or hardware configurations.

For example, the example embodiments disclosed herein may be encoded as a reading selection program 130 (also referred to as computer software, software applications, computer-readable instructions, or computer control logic) on a computer-readable medium. The computer-readable medium containing the program 130 may be stored in the memory 104. When executed by the processor 102, a computer program loaded into the computing system 100 may cause the processor 102 to perform and/or be a means for performing the functions of the example embodiments described and/or illustrated herein. Additionally or alternatively, the example embodiments described and/or illustrated herein may be implemented in firmware and/or hardware.

The reading selection program 130 can include a number of program modules. In the example of FIG. 1A, the program 130 includes an item selection manager 131, a reading rate calculator 132, a GUI manager 133, and an available time manager 134. The functionalities provided by these modules are described further below.

With reference to FIG. 1B, the computing system 100 stores (e.g., in the memory 104) information about items of content 150 (e.g., e-books, e-magazines or e-magazine articles, and e-comics) that have been downloaded to the computing system and/or are accessible via one or more reading devices linked to a user's e-reading account or e-library collection. An item of content is not necessarily an entire e-book or e-magazine, for example; an item of content may be, for example, one or more chapters in a book or one or more articles in a magazine.

Duration values (lengths of time) are associated with each of the items of content 150. A duration value is an estimate or prediction of the amount of time it will take a user to completely read a respective item of content. If a user has not yet started reading an item of content, then the duration value represents an estimate/prediction of the amount of time it will take for the user to read the item of content from beginning to end. If the user has already started reading an item of content and has bookmarked their progress in some manner, then the duration value represents an estimate/prediction of the amount of time it will take the user to finish reading the item of content.

Duration values (estimated/predicted times-to complete) may be based on, for example, statistics for the particular user tracked on the user's reading device. For example, the computing system 100 can track how often a user “turns” a page (transitions from one electronic page to another). Alternatively, the computing system can track the number of words that are read versus time. For example, the properties of an electronic document usually include the number of words in the document. Using that information, the number of words between a user's starting point and ending point in an item of content and the amount of time it took to get from that starting point to that ending point can be determined, and a reading rate (or at least an estimate) can then be calculated by dividing the number of words by the amount of time. Each time a user reads an item of content, a reading rate can be calculated and used to determine an average reading rate for the user.

Duration values may also or instead be based on, for example, more global statistics for a particular item of content. For example, the amount of time it takes for a group of people to read a particular item of content can be determined, and the average for that group can be used as the duration value for that item of content.

Duration values may also or instead be based on statistics tracked for similar items in the user's e-reading library or account. For example, reading rates can be determined as a function of the type of content: a rate can be determined for fiction e-books, another rate for non-fiction e-books, yet another rate for e-magazines, and so on. The reading rate may be influenced by, for example, whether or not the item of content includes a lot of pictures or other objects that reduce the number of words per page.

In summary, generally speaking, a duration value is associated with each item of content, and the duration value can be accessed by the computing system 100.

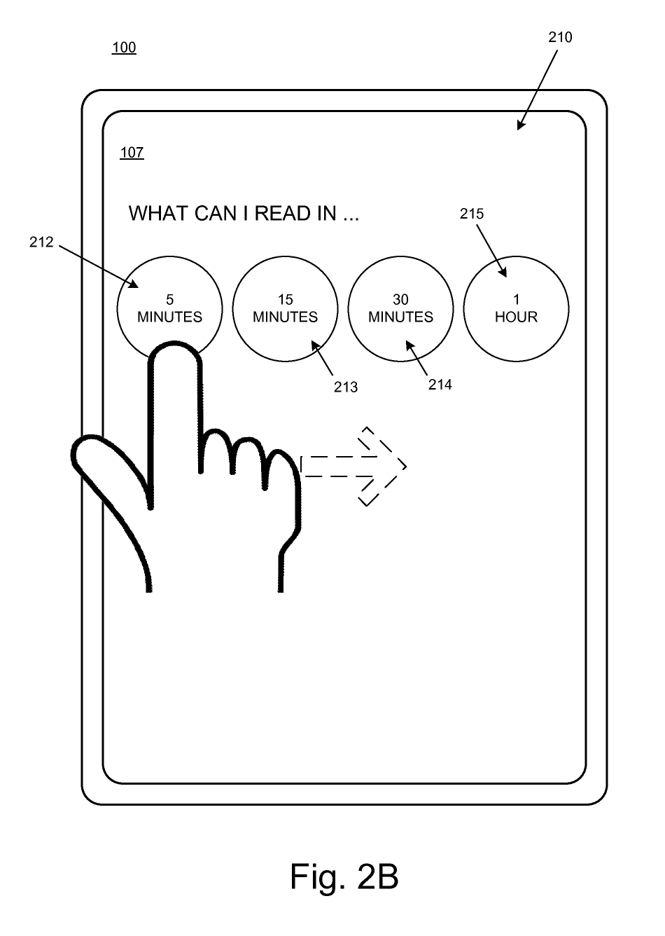

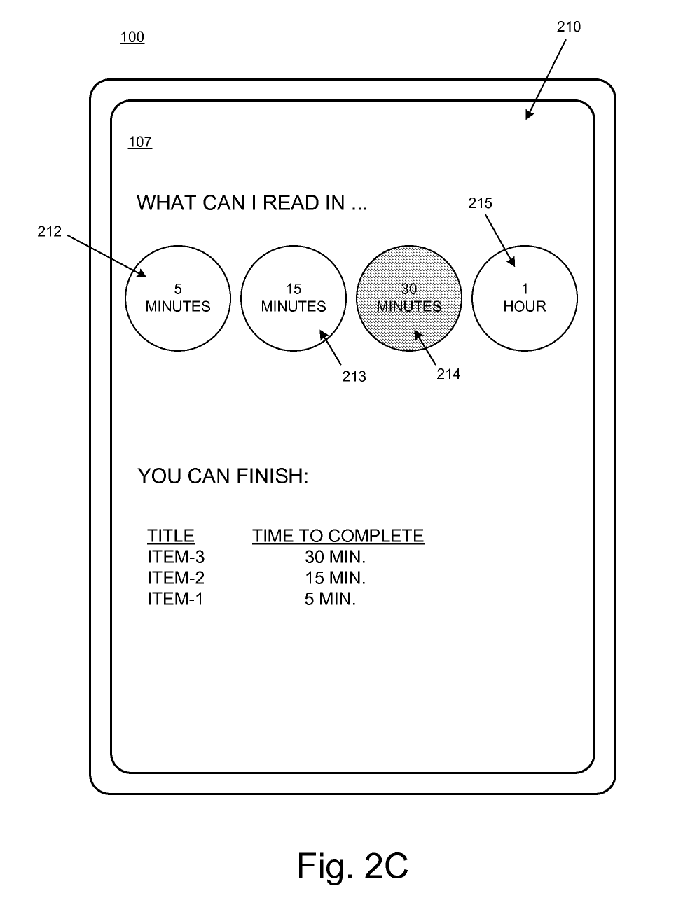

FIG. 2A illustrates a frontal view of an example of a computing system 100 in an embodiment according to the present invention. In the example of FIG. 2A, the touchscreen display 107 includes a GUI element 202. Other elements may be displayed at the same time within the touchscreen display 107.

The GUI element 202 may be persistently displayed, or it may be rendered as part of a toolbar or in response to user activation of another GUI element (not shown). Generally speaking, the GUI element 202 is readily accessible to a user. A user can select the GUI element 202 (e.g., touch it or click on it); in response, the reading selection program 130 (FIG. 1A) is activated.

FIG. 2B is an example of a GUI 210 that can be displayed on the touchscreen display 107 using the reading selection program 130. In the example of FIG. 2B, the GUI 210 includes a number of GUI elements 212, 213, 214, and 215 (212-215). In general, the elements 212-215 present different options and allow a user to conveniently select/input a window of time, e.g., five (5) minutes, 15 minutes, 30 minutes, or one (1) hour. Embodiments according to the invention are not limited to this number of options, nor are they limited to these amounts of time.

A user can select/activate (e.g., touch or click on) one of the GUI elements 212-215 to indicate an amount of time the user has available for reading or wants to spend reading. Alternatively, the user can touch (e.g., tap) one of the GUI elements 212-215 to highlight it, then move (e.g., swipe) the finger to another of the GUI elements, and then tap the display screen 107 again to make a selection. For instance, the GUI element 212 may be initially highlighted; by swiping or moving a finger to the right, the other GUI elements 213-215 are highlighted in turn; and when the user's finger is tapped against the display screen, the currently highlighted element is selected.

Once the user has made a selection of an amount of time, information about a selection of reading recommendations is displayed on the display screen 107, as shown in FIG. 2C. The reading recommendations are a subset of one or more of the items of content 150 (e.g., all or parts of e-books, e-magazines, and e-comics) that have been downloaded to the computing system 100 and/or are accessible via one or more reading devices linked to a user's e-reading account or e-library collection. The reading recommendations are determined using the duration values described above. For example, if the user selects 30 minutes as the amount of time available, then the reading recommendations are those items of content that have a respective duration value of less than or equal to 30 minutes. Reading recommendations that are a “best fit” to the available time slot could be presented. For example, if the user selects 30 minutes as the amount of time available, then an item of content with a duration value closest to 30 minutes would be presented over one with duration value that is further away from 30 minutes, as shown in FIG. 2C. The user can then select an item of content by touching its name on the display screen 107 in well-known fashion.

As mentioned previously herein, an item of content is not necessarily an entire e-book, for example, but may be a chapter or some other logical portion of an e-book; hence, there may be multiple items of content associated with a single e-book. The reading recommendations are selected based on knowledge by the computing system 100 (specifically, the reading selection program 130) of the relationships between items of content and also knowledge of which items of content have already been read by a user. For example, if a user has read the first two chapters of an e-book, then the reading selection program 130 could select and recommend the third chapter (if it fit within the available window of time); the program could also select the third chapter and other consecutive chapters (to the extent that they fit within the available window of time); but the program would not select the fourth chapter without the third chapter (even if the fourth chapter fit within the available window of time).

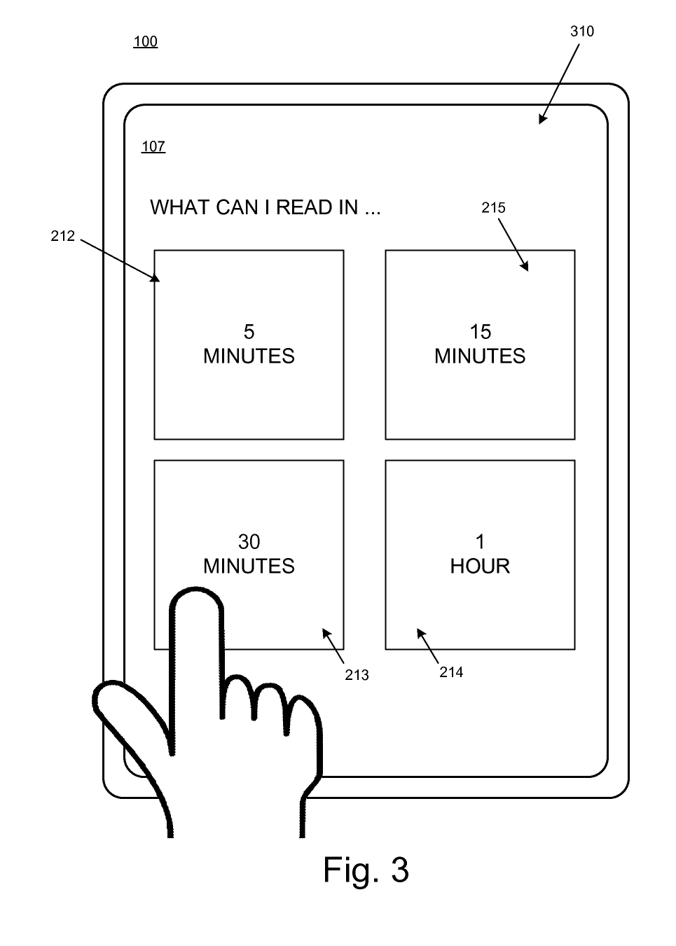

FIG. 3 is an example of another GUI 310 that can be displayed on the touchscreen display 107 using the reading selection program 130. In the example of FIG. 3, the GUI 310 includes GUI elements 312, 313, 314, and 315 (312-315). Similar to the example described above, a user can select one of the GUI elements 312-315 and, in response, information about a selection of reading recommendations is displayed on the display screen 107 (e.g., as in the example of FIG. 2C), where the reading recommendations are selected according to their respective duration values as described above. The user can then select an item of content by touching its name on the display screen 107 in well-known fashion.

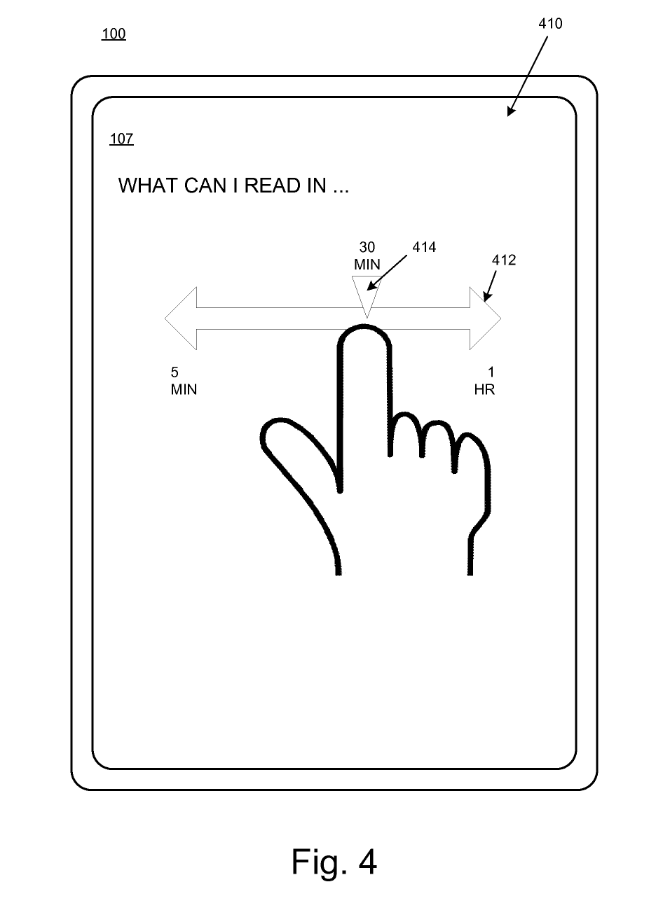

FIG. 4 is an example of another GUI 410 that can be displayed on the touchscreen display 107 using the reading selection program 130. In the example of FIG. 4, the GUI 410 includes a slider bar 412. A range of time values (e.g., one minute to 60 minutes) is associated with the slider bar 412. A user can move the indicator 414 back-and-forth along the slider bar 412 to select an amount of time available for reading. As the user moves the indicator 414 to the right, the selection of recommended reads may expand; as the indicator to the left, the selection of recommended reads may grow shorter. The user can then select an item of content by touching its name on the display screen 107 in well-known fashion. In contrast to the examples above, the GUI 410 permits a user to select from a range of time values instead of from some number of pre-selected time values.

Instead of a slider bar, a dial-like GUI element can be used. Other types of GUI elements can be used as well.

Other types of GUIs can be employed to allow a user to specify or select an amount of time; embodiments according to the invention are not limited to the above examples.

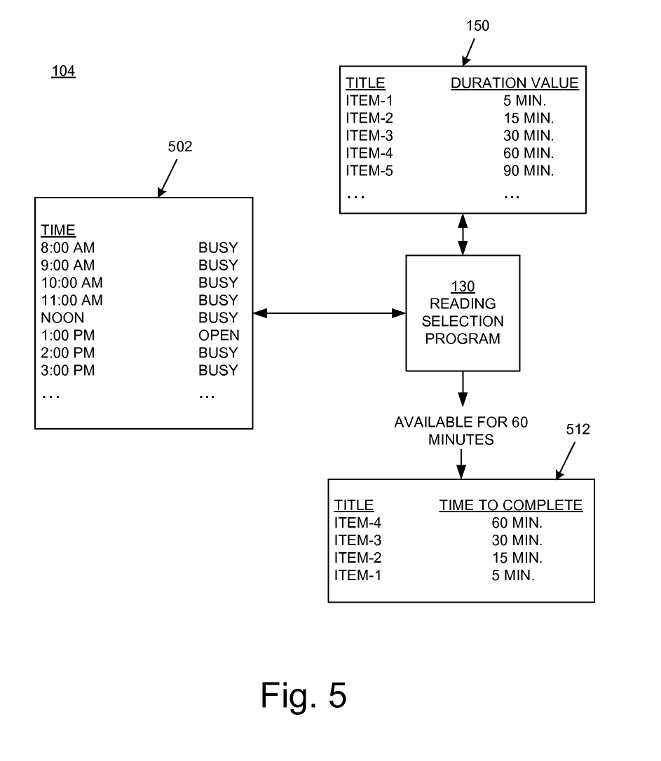

In the above examples, a user explicitly selects or specifies an amount of time. Alternatively, the computing system 100 can infer an amount of time available for reading using schedule information and/or other information about a user that is stored on the computing system or is otherwise available to the computing system. With reference to FIG. 5, the computing system 100 can access calendar information 502 that is stored, for example, in the memory 104. In the example of FIG. 5, the reading selection program 130 (FIG. 1) can see from the calendar information that the user has time available from 1:00-2:00 PM, can select a subset of the items of content 150 that have duration values that fit within that window of time (e.g., duration values that are less than or equal to 60 minutes), and can display information identifying the selected subset in a GUI element 512, as previously described herein. In the example of FIG. 5, the subset of reading recommendations is organized in best fit fashion as mentioned previously herein; that is, the items of content are prioritized so that the item with a duration value closest to the amount of time available is listed first.

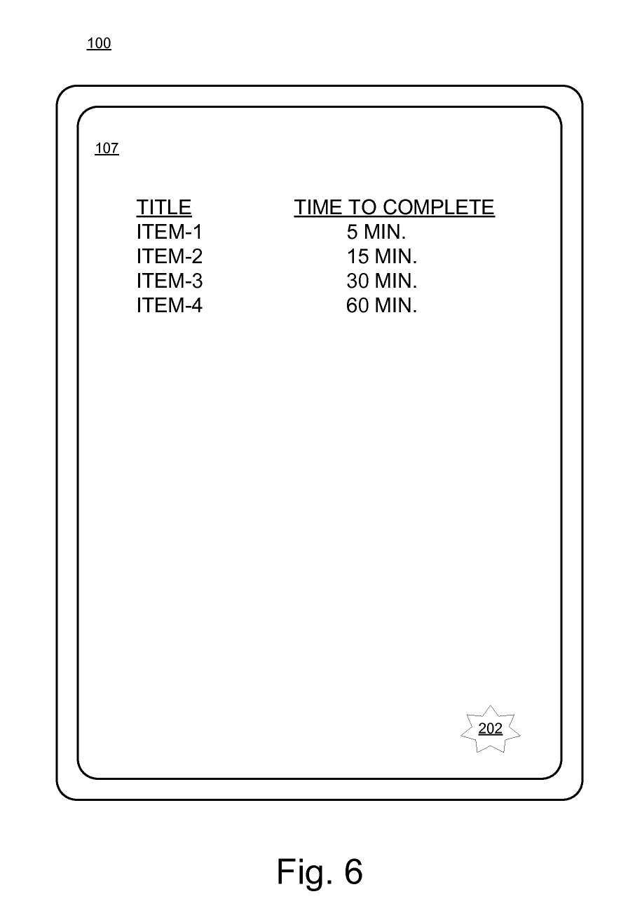

In the above examples, an amount of available time is explicitly or implicitly specified, and a selection of items of content is displayed in response. FIG. 6 is an example of another 6UI 410 that can be displayed on the touchscreen display 107 using the reading selection program 130. In the example of FIG. 6, a list 610 of the items of content 150 can be displayed along with their respective duration values. As shown in the example of FIG. 6, the list 610 can be sorted based on the duration values (time to complete). For example, the items of content in the list 610 can be arranged from shortest duration value to longest duration value.

The items of content in the list 610 can also be sorted using one or more other attributes associated with the items of content in combination with the duration values. For example, the items of content can be sorted first by duration value, then by author; or first by author, then by duration value.

Embodiments according to the present invention can also be used on devices other than e-book readers, and/or with items content other than electronic pages such as, but not limited to, videos.

As mentioned above, the example embodiments disclosed herein may be encoded as a reading selection program 130 (FIG. 1A). In one embodiment, the reading selection program 130 includes an item selection manager 131, a reading rate calculator 132, a GUI manager 133, and an available time manager 134 (program modules 131-134). The item selection manager 131 can access the items of content 150 (FIG. 1B) that are stored in the memory 104 and/or are accessible via one or more reading devices linked to a user's e-reading account or e-library collection, and can select reading recommendations based on inputs from the other modules. For example, the item selection manager 131 can track how far a user has progressed through each of the items of content, calculate duration values based on that information and reading rates, select the reading recommendations based on the amount of time that is available, and prioritize (e.g., sort) the reading recommendations. The reading rate calculator 132 can monitor the rates at which items of content are read, and can calculate reading rates as described previously herein. The GUI manager 133 can prepare a GUI such as the various GUIs and GUI elements described herein, and interpret the various user inputs received via the GUI, including the amount of time that is available. The available time manager 134 can infer the amount of time that is available based on, for example, a user's schedule information. There can be program modules other than those just described, the functionality performed by one module may instead be distributed across multiple modules, and the functionality described as being performed by separate modules may be performed by a single module. Generally speaking, when combined, the program modules 131-134 constitute elements of the reading selection program 130 and perform the various functions of that program that are described herein.

FIG. 7 is a flowchart 700 of an example of a computer-implemented method for selecting and presenting items of content based on estimated time to complete in embodiments according to the present invention. The flowchart 700 can be implemented as computer-executable instructions residing on some form of computer-readable storage medium (e.g., the reading selection program 130, executed using the computing system 100 of FIG. 1A).

In block 702 of FIG. 7, in one embodiment, a GUI element (e.g., the element 202 of FIG. 2A) is displayed on a display screen (e.g., a touchscreen) of a computing system (e.g., an e-book reader).

In block 704 of FIG. 7, in response to the GUI element being selected by a user, different items of content are accessed (e.g., the items of content 150 of FIG. 1B). A duration value that indicates a length of time (e.g., estimated or predicted time to complete) is associated with each item of the items of content.

In block 706 of FIG. 7, also in response to the GUI element being selected by a user, information identifying at least a subset of the items of content is displayed on the display screen, where the subset is selected according to the duration values.

In an embodiment, an amount of time that is available for reading is determined, and the subset is selected based on a comparison between the duration values and the amount of time that is available. An input indicating the amount of time that is available may be received from the user. The amount of time that is available may also be automatically determined by accessing schedule information associated with the user.

In an embodiment, information that indicates a rate at which content is read can be accessed, and the rate information can be used to determine the duration values. In such an embodiment, the rate may be a function of the type of content (e.g., a rate can be determined for fiction books, another rate for non-fiction books, yet another rate for magazines, and so on).

In an embodiment, the information displayed on the display screen is organized according to the duration values. For example, the subset of items presented for displayed may be sorted from the shortest duration value (the shortest time-to-complete) to the longest.

In summary, embodiments according to the present invention facilitate selecting an item of content for reading based on how well the time to complete reading the item of content fits into the time a user has available for reading. People can more quickly make informed decisions about which item of content to read, particularly when they can choose from a multiplicity of items of content in various stages of reading progress. As a result, people will be able to fit more reading into their everyday lives.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A non-transitory computer-readable storage medium having computer-executable instructions that, when executed, cause a computing system to perform a method comprising:
displaying a graphical user interface (GUI) element on a display screen of the computing system; and
in response to the GUI element being selected by a user:
accessing a plurality of different items of content, the items having associated therewith duration values that indicate a length of time for each item of the items of content; and
displaying, on the display screen, information identifying at least a subset of the items of content, the subset selected according to the duration values.

2. The non-transitory computer-readable storage medium of claim 1 wherein the computing system comprises an electronic book (e-book) reader and each of the items of content comprises at least a portion of e-book content that is displayable on the display screen.

3. The non-transitory computer-readable storage medium of claim 1 wherein the method further comprises:
determining an amount of time that is available for reading from the user; and
selecting the subset based on a comparison between the duration values and the amount of time that is available.

4. The non-transitory computer-readable storage medium of claim 3 wherein said determining comprises receiving an input from the user indicating the amount of time that is available.

5. The non-transitory computer-readable storage medium of claim 3 wherein said determining comprises accessing schedule information associated with the user to automatically determine the amount of time that is available.

6. The non-transitory computer-readable storage medium of claim 1 wherein the method further comprises:
accessing information that indicates a rate at which content is read; and
using the rate to determine the duration values.

7. The non-transitory computer-readable storage medium of claim 6 wherein the rate is a function of type of content.

8. The non-transitory computer-readable storage medium of claim 1 wherein the method further comprises organizing the information displayed on the display screen according to the duration values.

9. A system comprising:
a processor;
a display coupled to the processor; and
memory coupled to the processor, the memory have stored therein instructions that, if executed by the system, cause the system to execute operations comprising:
displaying a graphical user interface (GUI) element on the display screen; and
in response to the GUI element being selected by a user:
accessing information about a plurality of different items of content stored in the memory, the information comprising duration values that indicate a length of time for each item of the items of content; and
displaying, on the display screen, information about at least a subset of the items of content, the subset selected according to the duration values.

10. The system of claim 9, comprising an electronic book (e-book) reader, wherein each of the items of content comprises at least a portion of e-book content that is displayable on the display screen.

11. The system of claim 9 wherein the operations further comprise:
determining an amount of time that is available for reading from the user; and
selecting the subset based on a comparison between the duration values and the amount of time that is available.

12. The system of claim 11 wherein said determining comprises receiving an input from the user indicating the amount of time that is available.

13. The system of claim 11 wherein said determining comprises accessing schedule information stored in the memory to automatically determine the amount of time that is available.

14. The system of claim 9 wherein the operations further comprise:
accessing information that indicates rates at which content is read; and
determining the duration values using the rates.

15. The system of claim 14 wherein the rates are a function of type of content.

16. The system of claim 9 wherein the operations further comprise organizing the information about the subset that is displayed on the display screen according to the duration values.

17. A method comprising:
sensing that a user has selected a graphical user interface (GUI) element that is displayed on a touchscreen of a electronic book (e-book) reader;
in response to said sensing, accessing a plurality of different items of content stored on the e-book reader, the items having associated therewith duration values that associate a length of time for each item of the items of content, the duration values corresponding to an estimate of a measure of time needed to read remaining portions of the items of content;
displaying, on the touchscreen, information identifying at least a subset of the items of content, the subset selected according to the duration values; and
organizing the information displayed on the display screen according to the duration values.

18. The method of claim 17 further comprising:
determining an amount of time that is available for reading from the user; and
selecting the subset based on a comparison between the duration values and the amount of time that is available.

19. The method of claim 18 wherein said determining comprises receiving an input from the user indicating the amount of time that is available.

20. The method of claim 18 wherein said determining comprises accessing schedule information associated with the user to automatically determine the amount of time that is available.
